(19) United States
(12) Patent Application Publication
(10) Pub. No.: US 2020/0337296 A1
(43) Pub. Date: Oct. 29, 2020

(54) Cobalt-iron nanowires for remote heating using an alternating magnetic field

(71) Applicant: Regents of the University of Minnesota, Minneapolis, MN (US)

(72) Inventors: Daniel Eugene Shore, Minneapolis, MN (US); Zhe Gao, Minneapolis, MN (US); Ibro Tabakovic, Minneapolis, MN (US); John Bischof, Minneapolis, MN (US); Bethanie Joyce Hill Stadler, Minneapolis, MN (US)

(21) Appl. No.: 16/852,850

(22) Filed: Apr. 20, 2020

Related U.S. Application Data
(60) Provisional application No. 62/838,688, filed on Apr. 25, 2019.

(51) Int. Cl. A01N 1/02

(52) U.S. Cl. CPC A01N 1/0221; A01N 1/0294; A01N 1/0284

(57) ABSTRACT

Cryoprotective compositions with magnetic nanowires and cryoprotective agents are used to cryopreserve biomaterials. The biomaterials in the cryoprotective composition are rapidly and uniformly heated during warming to minimize damage due to cracking and/or devitrification. The nanowires are CoFe nanowires. The nanowires may be aligned parallel to the alternating magnetic field to increase the specific absorption rate of the nanowires. The methods include warming the cryopreserved biomaterial in the cryopreserved composition at a rate higher than the critical warming rate using an alternating magnetic field.

### CROSS REFERENCE TO RELATED APPLICATION

This application claims priority to and the benefit of U.S. provisional patent application Ser. No. 62/838,688, filed on Apr. 25, 2019, the content of which is hereby incorporated in its entirety.

### BACKGROUND

A significant challenge for organ and tissue transplantation is ischemic injury to tissue or organs during the time between removal from the donor and implantation in the recipient. Before transplantation, organs can be preserved by hypothermic storage up to 4 hours for hearts, and up to 36 hours for kidneys. To improve the success rate for tissue and organ transplantation, they can be cryopreserved by vitrification, an approach that converts liquid to glass without crystallization. While there have been recent advances in vitrifying tissues or organs, successful rewarming of large volumes is still challenging.

### SUMMARY

In one aspect, the present description relates to a cryopreserved composition. The cryopreserved composition includes a cryoprotective composition and a biomaterial. The cryoprotective composition includes at least one cryoprotective agent and magnetic nanowires. The biomaterial is perfused with and/or suspended in the cryoprotective agent in the cryopreserved composition. The cryopreserved material may be a minimum dimension of 0.1 mm. The cryoprotective agents may have a molarity of less than 9 M. The magnetic nanowires may be CoFe nanowires. The magnetic nanowires may be Co₃₅Fe₆₅ nanowires. The total concentration of the magnetic nanowires in the cryoprotective composition may include between about 1 mg CoFe/mL and about 100 mg CoFe/mL of cryoprotective composition. The cryopreserved composition includes minimal damage. The nanowires may have a length between about 100 nm and about 20 μm. The nanowires may have a diameter between about 10 nm and about 200 nm. The nanowires may be tipped with gold. The minimal damage can include sufficiently minimal structural damage to the biomaterial that the biomaterial is suitable for transplantation. The biomaterial may include an organ or portion thereof, a tissue or portion thereof, and/or cells. The nanowires in the cryopreserved composition may be aligned in a parallel manner.

In another aspect, the present description includes a composition including a biomaterial perfused with and/or suspended in a cryoprotective composition. The cryoprotective composition includes at least one cryoprotective agent and magnetic nanowires effective for warming the biomaterial with minimal biomaterial damage after cryopreservation. The biomaterial may include an organ or portion thereof, a tissue or portion thereof, or cells. The nanowires may be aligned in a parallel manner.

In a further aspect, the present description relates to a method of cryopreserving a biomaterial. The method includes placing a biomaterial in contact with a cryoprotective composition, wherein the cryoprotective composition includes at least one cryoprotective agent and magnetic nanowires. The method further includes cooling the biomaterial in the cryoprotective composition to form a cryopreserved composition. The method may further include aligning the magnetic nanowires prior to or during cooling of the biomaterial in the cryoprotective composition. The method may further include applying electromagnetic energy to warm the cryopreserved composition. The electromagnetic energy may be an alternating magnetic field. The method may further include warming the cryopreserved composition in AMF to rapidly and uniformly heat the cryopreserved composition without devitrification or cracking. The warming may be performed at a rate above the critical warming rate of the cryoprotective agent. The method of claim 24 wherein the magnetic nanowires are CoFe nanowires.

In yet another aspect, the present description includes a method of treating a cryopreserved composition with a biomaterial. The method includes applying electromagnetic energy to the cryopreserved biomaterial wherein the biomaterial is cryopreserved in a. cryoprotective composition, wherein the cryoprotective composition includes at least one cryoprotective agent and magnetic nanowires. The magnetic nanowires may be effective for warming the biomaterial when electromagnetic energy is applied. The warming may occur with minimal biomaterial damage and wherein electromagnetic energy is applied to the cryopreserved biomaterial at an intensity sufficient to excite the magnetic nanowires and warm the biomaterial. The electromagnetic energy may include applying an alternating magnetic field (AMF). The AMF applied may be between about 20-100 kA/m. The cryopreserved biomaterial may be perfused with the cryoprotective composition. The cryopreserved biomaterial may be suspended in the cryoprotective composition. The cryopreserved biomaterial may have a volume with a minimum dimension of at least 0.1 mm. The cryopreserved biomaterial may be warmed with minimal damage. The cryopreserved biomaterial may be warmed at a rate of at least 50° C./minute throughout. The nanowires may be aligned in the cryopreserved biomaterial.

In yet a further aspect, the present description includes an apparatus. The apparatus includes a DC power supply; a magnetic coil operably connected to the power supply; and a cryopreserved biomaterial with magnetic nanowires. The cryopreserved biomaterial may be placed within the magnetic coil, wherein activation of the power supply aligns the magnetic nanowires and warms the cryopreserved biomaterial. The nanowires may be CoFe nanowires. The warming may occur in a rapid and uniform rate without devitrification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a plot of a hysteresis loop for 8 μm Ni nanowires aligned in an AAO membrane parallel to the applied field.

FIG. 2A is a photograph of cross-sectional SEM images of Co₃₅Fe₆₅ 16 μm nanowires aligned in an AAO template.

FIG. 2B is a photograph of cross-sectional SEM images of Co₃₅Fe₆₅ 2 μm nanowires aligned in an AAO template.

FIG. 2C is a photograph of cross-sectional SEM images of released Au-tipped Ni nanowires.

FIG. 3A is a plot of SAR values for nanowires with different Mₛ in glycerol at various concentrations.

FIG. 3B is a plot of a hysteresis loop for 8 μtm Co₃₅Fe₆₅ nanowires aligned in an AAO membrane parallel to the applied field. (Note 1 kOe=79.6 kA/m)

FIG. 3C is a plot of a hysteresis loop for 8 μm Fe nanowires aligned in an AAO membrane parallel to the applied field.

FIG. 3D is a plot of a hysteresis loop for 8 μm Co nanowires aligned in an AAO membrane parallel to the applied field.

FIG. 4A is plot of SAR values for different length Co₃₅Fe₆₅ nanowires in glycerol at various concentrations.

FIG. 4B is a plot showing the SAR values for different length Co₃₅Fe₆₅ and Fe nanowires in glycerol at various concentrations. The asterisk marker indicates the nanowires were randomly oriented while the square marker indicates the nanowires were aligned parallel to the AMF before heating.

FIG. 5A is a plot of SAR values for 6 and 8 μm Co₃₅Fe₆₅ nanowires in glycerol at various concentrations, with the nanowires randomly oriented or aligned parallel to the AMF.

FIG. 5B is a plot of heating curves for 8 μm Co₃₅Fe₆₅ nanowires (5 mg/ml) in VS55 at 360 kHz and 20 or 25 kA/m.

FIG. 5C is a plot of heating curves for 8 μm Co₃₅Fe₆₅ nanowires at 1, 2.5, or 5 mg Co₃₅Fe₆₅/ml at 25 or 30 kA/m with the nanowires randomly oriented or aligned parallel to the AMF.

FIG. 5D is a plot of minor hysteresis loops of 8 μm Co₃₅Fe₆₅ nanowires aligned in an AAO membrane parallel to the applied field. The loops ranged from ±20, ±25, ±30, ±40, ±50, and ±60 kA/m (±0.25, ±0.31, ±0.38, ±0.5, ±0.63, and ±0.75 kOe).

FIG. 6A is a plot of viability of HDF cells. Cells with no nanowires in cell culture medium with AMF 0, 25, or 30 kA/m, for 3 minutes.

FIG. 6B is a plot of viability of HDF cells. Cells in VS55 with 0, 1 or 2.5 mg Co₃₅Fe₆₅/mL of nanowires without AMF. Cell viability was tested after the complete removal of VS55 and/or Co₃₅Fe₆₅ nanowires.

FIG. 7 is a schematic diagram of Multistep fabrication process for magnetic nanowires. Note that CoFe segment was replaced with Fe, Co, Ni for comparing different Ms nanowires.

FIG. 8 is a photograph of the Helmholtz coil and DC power supply used to magnetically align the nanowires prior to SAR or nano-warming measurements.

FIG. 9A is a plot of a temperature curve for 8 μm CoFe nanowires in glycerol at different concentrations.

FIG. 9B is a plot of a temperature curve for 8 μm Co nanowires in glycerol at different concentrations.

FIG. 9C is a plot of a temperature curve for 8 μm Ni nanowires in glycerol at different concentrations.

FIG. 9D is a plot of SAR values for different length CoFe nanowires in glycerol at various concentrations.

FIG. 10 is a plot of nanowarming temperature curves for three different 8 μm CoFe nanowire samples which were aligned parallel with the AMF prior to being vitrified.

FIG. 11A is a plot of hysteresis curves for 8 μm Ni nanowires aligned in AAO parallel with the applied magnetic field. The reversal fields for the hysteresis loops were 20, 25, 30, 40, 50 and 60 kA/m (±0.25, ±0.31, ±0.38, ±0.5, ±0.63, and ±0.75 kOe).

FIG. 11B is a plot of hysteresis curves for 8 μm Co nanowires aligned in AAO parallel with the applied magnetic field. The reversal fields for the hysteresis loops were 20, 25, 30, 40, 50 and 60 kA/m (±0.25, ±0.31, ±0.38, ±0.5, ±0.63, and ±0.75 kOe).

FIG. 11C is a plot of hysteresis curves for 8 μm Fe nanowires aligned in AAO parallel with the applied magnetic field. The reversal fields for the hysteresis loops were 20, 25, 30, 40, 50 and 60 kA/m (±0.25, ±0.31, ±0.38, ±0.5, ±0.63, and ±0.75 kOe).

### DETAILED DESCRIPTION OF ILLUSTRATIVE EMBODIMENTS

The present description includes the use of magnetic nanowires in cryopreservation compositions and methods. The cryopreservation composition can include one or more cryoprotective agents and magnetic nanowires. The magnetic nanowires can have high magnetic anisotropy and high specific absorption rate (SAR) when a magnetic field is applied. The inclusion of magnetic nanowires in a cryopreserved biological sample enables rapid, uniform heating that can improve the viability of the biological sample upon thawing.

The present description also includes methods for cooling and thawing a biological sample. The biological sample can be placed in the cryopreservation composition, vitrified and stored. In some embodiments, the nanowires in the cryopreservation composition may be aligned parallel to the alternating magnetic field prior to and/or during cooling. When desired, the vitrified composition may be warmed by applying a magnetic field. The nanowires can have high SARs and enable rapid, uniform heating above the critical warming rate.

In one embodiment, the nanowires (NWs) can be Cobalt-iron (CoFe) nanowires that can be fabricated by reducing cobalt and iron ions, in a mixed electrolyte system using an external power supply for the reduction reaction. The magnetic CoFe nanowires can be used for cryopreserving biological samples in a cryoprotectant solution. When desired, the cryopreserved composition with the nanowires can be thawed by warming the magnetic nanowires in an alternating magnetic field (AMF). The nanowires can also be used for other applications that require uniform remote heating such as hyperthermia therapy for cancer and thermally curing materials, such as adhesives.

### DEFINITIONS

Various terms are defined herein. The definitions provided below are inclusive and not limiting, and the terms as used herein have a scope including at least the definitions provided below.

The terms “preferred” and “preferably”, “example” and “exemplary” refer to embodiments that may afford certain benefits, under certain circumstances. However, other embodiments may also be preferred or exemplary, under the same or other circumstances. Furthermore, the recitation of one or more preferred or exemplary embodiments does not imply that other embodiments are not useful, and is not intended to exclude other embodiments from the inventive scope of the present disclosure.

The singular forms of the terms “a”, “an”, and “the” as used herein include plural references unless the context clearly dictates otherwise. For example, the term “a tip” includes a plurality of tips.

Reference to “a” chemical compound refers to one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element are used interchangeably, and have the same meaning that includes a single element and a plurality of the elements, and may also be represented by the suffix “(s)” at the end of the element.

The terms “about” and “substantially” are used herein with respect to measurable values and ranges due to expected variations known to those skilled in the art (e.g., limitations and variability in measurements).

The term “and/or” means one or all of the listed elements or a combination of any two or more of the listed elements.

The terms “comprises,” “comprising,” and variations thereof are to be construed as open ended—i.e., additional elements or steps are optional and may or may not be present.

Unless otherwise specified, temperatures referred to herein are based on atmospheric pressure (i.e. one atmosphere).

“Cryopreservation” as referred to herein relates to preservation of a biological sample at cryogenic temperatures. Cryopreservation includes cooling/freezing/vitrifying the biological sample below subzero temperatures in order to shut down metabolic/chemical activity, thereby allowing long term storage of biomaterials.

“Cryogenic” or “Cryogenic temperature” as referred to herein relates to a temperature below sub-zero. Cryogenic temperature can be from −80° C. (−112° F.) to absolute zero (−200° C. or −328° F.).

“Cryogenic coolant” as referred to herein relates to a substance that is at a cryogenic temperature, e.g. liquid nitrogen. It will be understood that reference to liquid nitrogen in the disclosure herein is exemplary and that other cryogenic coolants may also be used and are within the scope of this description.

“Vitrification” or “glass transition” as referred to herein relates to a transition of a liquid to an amorphous solid state in which little or no long-range crystalline structure is present. This is contrasted with the transition of a liquid to a crystalline solid state, which implies undergoing a phase transition that releases the latent heat of fusion. Vitrification is achieved by the presence of cryoprotective solution, by the osmotic extraction of water from biological material suspended in the cryoprotective solution, by the introduction of permeating cryoprotective solution into the biological material, by removing substances that promote crystal formation or blocking their crystal-forming properties, and/or by very rapid cooling. Vitrified samples can have less than about 0.1% V/V of ice crystallization in the sample. Vitrification can prevent the formation of lethal ice that can destroy the viability of biological material.

“Glass” and “glassy” as referred to herein relate to a substance that has undergone vitrification.

“Liquid nitrogen” as referred to herein relates to liquid-phase nitrogen, which under standard temperature and pressure conditions remains at −196° C. and boils off continuously, producing very cold gaseous-phase nitrogen that is released to the environment.

“Crystallized” or “devitrified” sample as referred to herein relate to a biological sample that has attained some crystalline structure upon cooling, warming, or transient warming followed by cooling, and may not produce a viable biological sample upon warming to room or physiological temperature.

“Biological material”, “biological sample” and “biomaterial” as referred to herein relates to, for example, tissue, parts of a tissue, an organ (e.g. for transplantation), parts of an organ, a cell monolayer, cellular matrix and/or a cell suspension. These terms may be used interchangeably. Biological material may be derived from any biological source such as human, animal, plant, bacteria and the like.

“Cryoprotective agent” as referred to herein can include, for example, dimethyl sulfoxide (DMSO), propylene glycol (PG), VS55, trehalose, and the like. This list of chemicals is non-exhaustive and the exact composition of the solution can vary according to the biological material that is being vitrified

“Cryoprotective solution” or “cryoprotective composition” as referred to herein relate to a composition that protects the biological sample during vitrification and during warming after cryopreservation. Cryoprotective composition can include one or more cryoprotective agents and magnetic nanowires. Other components may also be included that protect the biological sample during vitrification and warming.

As used herein, “cryopreserved” refers to a biomaterial—e.g., a tissue sample, organ, portion of an organ, cell suspension, or cell monolayer—that has been perfused with or suspended in a cryoprotective composition as described herein and cooled as described in more detail below.

“Cryopreserved composition” or “cryopreserved sample” as referred to herein can include the biological sample and the cryoprotective composition. The biological sample may be immersed, perfused, coated, suspended or be in contact in any manner with the cryoprotective composition. Other components may also be included that protect the biological sample during vitrification and warming.

“Cryoprotective” and “cryoprotectant” can be used interchangeably.

“Saturation magnetization” as referred to herein is the net magnetization of a material when the magnetic moments of its atoms are aligned in the same direction for ferromagnetic materials, or in an ordered state of maximum alignment for ferrimagnetic or antiferromagnetic materials.

In the following detailed description of illustrative examples, reference is made to specific embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the examples in which they are incorporated, do not limit other embodiments, and any reference to the elements, operation, and application of the examples serves only to define these illustrative examples. Features or elements shown in various examples described herein can be combined in ways other than shown in the examples, and any such combination is explicitly contemplated to be within the scope of the examples presented here. The following detailed description does not, therefore, limit the scope of what is claimed.

All patents, publications or other documents mentioned herein are incorporated by reference.

Cryopreservation is commonly used to protect biomaterials such as, for example, a tissue, an organ (e.g., for transplantation), a cell monolayer, or a cell suspension, but may be constrained by the toxicity of cryoprotectant chemicals and/or difficulty in uniformly and rapidly heating and cooling the biomaterial. Successful nanowarming of biological samples requires a rapid, uniform heating rate above the critical warming rate of the cryoprotective agent. In one embodiment, the critical warming rate (CWR) of a cryoprotective agent can be, for example, about 50° C./min. If the sample is heated too slowly, crystallization during warming can damage the cells or tissue. If the sample is not heated uniformly, thermal stresses can cause cracking. Both of these problems can damage the biological sample and it will not be viable.

Traditional cryopreservation is limited because of constraints on freezing and thawing biomaterials. Many current techniques allow for sufficiently rapid cooling (sometimes with the addition of high pressure for bulk systems), but they do not allow sufficiently rapid thawing after cryopreservation. The use of cryoprotectant chemicals can decrease the negative effects of, for example, ice crystals forming in the biomaterial during cooling and/or non-uniform and slow thawing. However, cryoprotectants at high concentrations can be toxic to biomaterials. Cryopreservation is described, for example, in U.S. Patent Publication 2016/0015025, incorporated herein by reference.

In some embodiments, this disclosure describes methods and compositions involving rapid and uniform heating of cryopreserved biomaterials. This can result in lower thermal stresses (e.g., avoiding cracks) and little or no denitrification (e.g., avoiding crystals) on the cryopreserved biomaterial, which can translate to improved survival. The process may allow a. significant reduction in the concentration of cryoprotectants that are required in the cryopreservation process. A reduced concentration of cryoprotectants can extend the application of cryopreservation to larger biomaterials such as, for example, tissue slices, heart valves, and kidneys. The technology also can be used, for example, to preserve blood samples, stem cells, and reproductive biomaterials.

The cryopreservation methods described herein can include a cryoprotectant solution that includes magnetic nanowires to preserve biomaterials. A biomaterial may be submerged in or perfused with a cryoprotectant solution prior to rapid cooling to a vitreous (a non-crystalline or amorphous) state. In some embodiments, the nanowires may be aligned, for example, by using a low external DC field during vitrification. A uniform AMP can be applied for controlled interaction with the magnetic nanowires, leading to the rapid generation of heat at nanowires sites dispersed throughout the biomaterial. This rapid generation of heat at dispersed sites results in quick and uniform thawing of cryopreserved biomaterial.

Adding magnetic nanowires to cryoprotectant solutions can allow rapid heating in a uniform AMF. Since the resulting thawing is rapid and uniform, lower concentrations of cryoprotectants can be required and cracking due to thermal stress can be reduced. This can result in lower toxicity and improved viability of cryopreserved biomaterial.

The use of AMFs in conjunction with magnetic nanowires can allow heating rates greater than at least 50° C./min. In some embodiments, the biomaterial may be warmed at a minimum rate of at least 75° C./min, or at least 100° C./min, or at least 125° C./min, or at least 150° C./min, or at least 175° C./min, or at least 200° C./min, or at least 225° C./min, or at least 250° C./min, or at least 275° C./min, or at least 300° C./min. In some embodiments, the biomaterial may be warmed at a maximum rate of no more than 100,000° C./min such as, for example, no more than 1500° C./min, no more than 1000° C./min, no more than 750° C./min, no more than 500° C./min, no more than 400° C./min, no more than 300° C./min, no more than 250° C./min, no more than 200° C./min, no more than 175° C./min, or no more than 150° C./min. In some embodiments, the biomaterial may be warmed at a rate within a range having endpoints defined by any minimum rate listed above and any maximum rate listed above that is greater than the minimum rate.

In some embodiments, the biomaterial may be warmed at a rate of about 300° C./min. In other embodiments, the biomaterial may be warmed at a rate of about 225° C./min or about 175° C./min.

The heating rate with nanowires may be about a ten-fold increase or greater in the heating rate compared to nanospheres. This rapid warming can allow for the use of lower concentration of cryoprotectant chemicals—e.g., 4 M or lower, compared to current standard cryoprotectant concentrations of 8 M needed for vitrification. Since only certain biomaterials can resist toxic effects that can be caused by the higher 8M concentration of cryoprotectants, the lower concentration of cryoprotectant chemicals needed to protect biomaterials in the methods described herein makes cryopreservation a viable option for a broader scope of biomaterials than is currently possible with vitrification approaches. The rate of warming of a cryopreserved biomaterial can vary and can be dependent on a number of factors such as the CPA, the magnetic field applied, the frequency applied and the like. In some embodiments, the high magnetic moments of the CoFe nanowires can lead to a heating rate of at least about 10× faster per nanoparticle mass, or at least about 20× faster per nanoparticle mass than some iron oxide nanoparticles.

Vitrification, the freezing to a “glassy” rather than crystalline phase, is a form of cryopreservation and an important enabling approach for cellular and regenerative medicine. Vitrification offers the ability to store and transport cells, tissues, and/or organs for a great variety of biomedical uses. The methods disclosed herein can result in uniform heat generation within the biomaterial and is therefore not dependent on size or convective boundary condition and, therefore, overcomes fundamental limitations experienced with protocols that involve boundary convection or microwave heating. The methods and compositions herein can allow cryopreservation for larger volumes of samples that include biomaterials, where devitrification and/or cracking routinely result in preservation failures using conventional cryopreservation methods. Moreover, faster warming rates may allow one to reduce the amount of potentially toxic cryoprotective agents needed to avoid denitrification.

In some embodiments, the present description includes a cryoprotectant composition. The cryoprotectant composition can include magnetic nanowires. The nanowires can include a variety of materials or combination of materials. The nanowires can include, for example, iron, cobalt, nickel, copper, gold or any material that can be electroplated. The nanowires can also include a combination of these materials, as alloys or multilayers. In some embodiments, the nanowires can be Cobalt/iron (CoFe) nanowires. In one embodiment, the nanowires can be Fe₃₅Co₆₅ nanowires. It is to be understood that the description may be discussed with reference to CoFe nanowires, but other nanowires may also be used and are within the scope of this description.

In some embodiments, the nanowires can be tipped and/or interspersed with additional materials, e.g. gold or any material that can be electroplated. In one embodiment, the CoFe nanowires are gold tipped. In one embodiment, the nanowires may have gold interspersed within the CoFe nanowires.

The present description can also include fabrication of the nanowires. In one embodiment, a working electrode can have a nanoporous membrane such as, for example, anodic aluminum oxide, AAO with a conductive coating on one side. The Co and Fe ions can be reduced inside the nanopores of the membrane as described, for example, in Ghemes, A. et al. J. of The Electrochemical Soc. Vol. 164, (2)D13-D22 2017, incorporated in its entirety by reference herein.

The diameters of the nanopores of the membrane can dictate the diameters of the CoFe nanowires. Nanowires with a variety of diameters may be used in the cryopreservative compositions described herein. In some embodiments, the diameter of the nanowires can be as small as about 10 nm. In some embodiments, the diameter of the nanowires can be greater than about 50 nm, or greater than about 100 nm, or greater than about 200 nm. In one embodiment, the diameter of the nanowires is between about 20 nm and about 300 nm. Diameters of nanowires outside of this range are also within the scope of this description.

The electrodeposition time can determine the lengths of the nanowires. Nanowires with a variety of lengths may be used in the cryopreservative compositions described herein. In some embodiments, the length of the nanowires can be at least about 10 nm. In some embodiments, the length of the nanowires can be greater than about 500 nm, or greater than about 1 μm, or greater than about 5 μm or greater than about 10 μm. In one embodiment, the length of the nanowires can be between about 10 nm and about 100 μm. Lengths of nanowires outside of this range are also within the scope of this description.

After synthesis, the nanowires can be released from the membrane by dissolving the conductive layer. In one embodiment, the Cu is dissolved using 1.0 M Fe nitrate. Other methods for dissolving the conductive layer may also be used. The nanowires may also be released by dissolving the membrane. In one embodiment, the membrane AAO can be dissolved using 1.0 M NaOH. Other method of dissolving membranes may also be used.

The nanowires can be magnetically collected and then washed, for example, with deionized water.

The surfaces of the nanowires may, optionally, be coated with a variety of materials to improve biocompatibility. Naked metallic nanowires can oxidize in air or water, resulting in reduced magnetization. In some embodiments, the nanowires can be coated with HS-PEG-COOH on the Au-tips, and dopamide-PEG on the Co₃₅Fe₆₅, Fe, Co, or Ni surfaces. In one embodiment, the CoFe nanowires are coated with polyethylene-glycol (PEG) using an aqueous solution of PEG which has a dopamine group. The hydrophilic PEG can improve the buoyancy and dispersibility of the nanowires in water by mitigating the magnetic attractive forces between them. Coatings can be applied with ionic bonding via amine groups. Hyst-Ni is also possible. End groups can be attached to enable specific binding to desired cells, tissues, or other biospecies

After coating, the nanowires can be magnetically collected to remove the PEG solution. The nanowires may be placed in a desired cryoprotective agent. A variety of cryoprotective agents may be used and are disclosed herein. In one embodiment, the CoFe nanowires are in VS55, a cryoprotective agent.

In some embodiments, the nanowires can be uniformly dispersed in a cryopreservative solution. A variety of methods may be used to disperse the nanowires in a cryopreservative composition. In one embodiment, ultrasonication can be used to ensure the nanowires are uniformly dispersed. Ultrasonication is known in the field and any method of ultrasonication may be used.

The cryopreservative composition with the nanowire suspension can be used for vitrifying and cryopreserving biological samples. Vitrified biological samples in the cryopreservative compositions can be rapidly heated in a uniform AMF as described herein. This warming can be especially rapid if the nanowires are aligned using a low external DC field during vitrification.

Aspects of the disclosure apply an alternating current to a magnetizing coil to excite an AMF inside or near the magnetizing coil. When the AMF is applied to magnetic nanowires, the AME is effective in changing the magnetic state of the one or more magnetic nanowires. As used herein, the term “near” broadly covers any distance sufficient for the alternating magnetic field to effect and/or affect the oscillation of the nanowires. In one embodiment, “near” can include that the magnetic nanowires are inside the magnetizing field. The distance at which the AMF is applied may also depend on the intensity of the AMF. For example, an AMF having a stronger intensity may be located farther away from the location holding the magnetic nanowires than an AMF having a lower intensity

In an AMF, the heat generated by magnetic nanoparticles (MNPs) in each cycle can be written as:

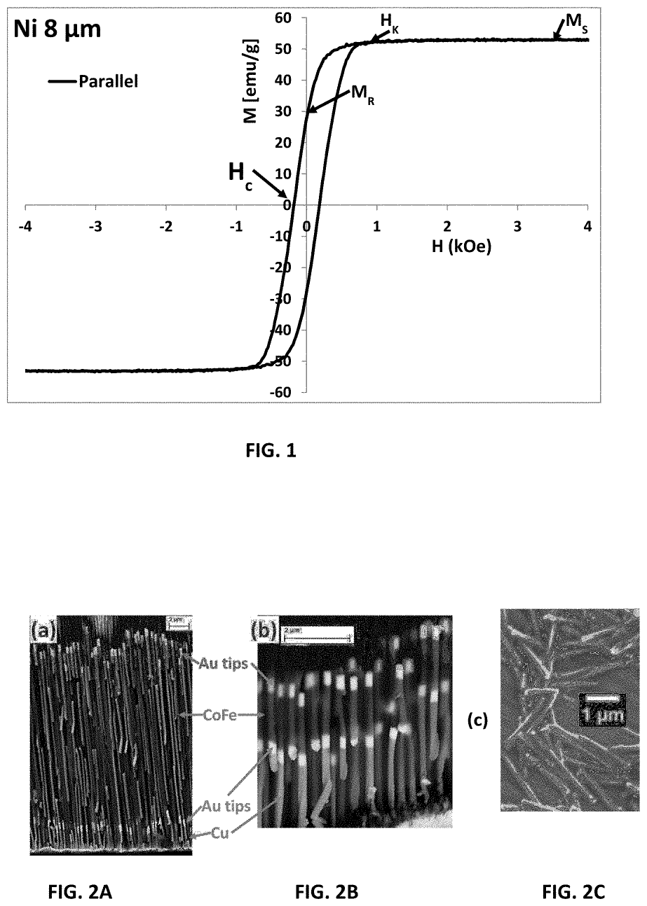

Wₕₑₐₜ= [symbol] H·dM (1)

where Wₕₑₐₜ is the net work, converted into heat, H is the applied magnetic field and M is the magnetization. Therefore, Wₕₑₐₜ is equal to the area inside the hysteresis loop. FIG. 1 shows the hysteresis loops for Au-tipped 8 μm nickel (Ni) nanowires oriented parallel or perpendicular to an applied magnetic field. The characteristic points are indicated, namely the magnetic saturation (Ms), the remnant magnetization (M_{R}) at 0 applied field, the coercive magnetic field (Hc) needed to demagnetize the sample, and the anisotropy field (H_{K}) which is the field required to fully align the magnetization in a given direction. For nanowires, the parallel hysteresis loop has the largest area with a height=2(Ms) and width=2(μ₀Hk), where μ₀ is the permeability of free space

μ₀H_{K}=2K/Mₛ (2).

The maximum heat generated is calculated as equation (3):

W^{max}ₕₑₐₜ=4Mₛμ₀Hₖ (3)

This can be simplified as:

W^{max}ₕₑₐₜ=8K (4)

where K is the anisotropy energy density, or the energy required to change the magnetization of the material from a particular direction with respect to its physical structure.

These equations show that the magnetic anisotropy of the MNPs has an important role in determining the heating properties of the particles. Without being bound by theory, it is understood that the main sources that can contribute to anisotropy energy density for MNP systems can be magnetocrystalline anisotropy, shape anisotropy, surface/interface anisotropy, colloidal anisotropy, and magnetoelastic anisotropy. Magnetocrystalline anisotropy can be due to the crystal structure dictating a preferred orientation for the atomic magnetic moments relative to the crystallographic axes. Shape anisotropy can occur when the shape of the magnetic material causes a preferred orientation of the magnetic moment with respect to the major/minor axes of the particle to minimize the energy of magnetostatic fields. This is common for high aspect ratio (length: diameter) MNPs that have length>>diameter (e.g. nanowires, or nanorods). Colloidal anisotropy can arise from interactions among magnetic nanoparticles suspended in a liquid that permits the formation of higher order structures such as chains. If the MNPs are in close to each other, then the magnetic dipole-dipole interactions between neighboring particles can affect the switching properties among the MNPs. Magnetoelastic anisotropy arises from the coupling between stress and magnetostriction of magnetic material.

The nanowires in the cryoprotective compositions described herein have advantageously high magnetic moments. In some embodiments, the nanowires can have magnetic moments higher than, for example, iron oxide nanoparticles. In some embodiments, saturation magnetization for the nanowires can be, for example, about 2.45 T or lower. In one embodiment, the saturation magnetization can be between about 2.0 T and about 2.45 T.

The nanowires in the cryoprotective compositions described herein can have high magnetic anisotropy. The high magnetic anisotropy can be high due to any of the factors described above, e.g. shape, size, arrangement, dipolar interactions and the like. Both the diameter and length can determine the shape anisotropy. This can affect the magnetic properties of the nanowires. The magnetic anisotropy of the nanowires can be, for example, up to 2*π*Ms which for CoFe could be as high 2.45 T.

The nanowires in the cryoprotective composition can advantageously have a high specific absorption rate (SAR). The SAR can vary and can be dependent on the specific composition of the nanowires.

The magnetic nanowires may provide, for example, at least about 5 Joules (J)/gram (g) of nanowire, or at least about 7.5 J/g of nanowire, or at least about 10 J/g of nanowire. The magnetic nanowires may provide power, for example, of at least about 1000 watts (W)/g of nanowire, or at least about 1500 W/g of nanowire. Values outside of these ranges are also within the scope of this description. Values can vary depending on the AMF field strengths and frequencies and these are described in greater detail herein.

In some embodiments, magnetic nanowires can provide up to 7.6 mJ/g (energy per gram nanowire) at AMF field strengths of 25 kA/m, and with proper engineering of magnetization reversal, this value will scale with AMF field strength. This energy leads to power delivery of 1400 W/g at 150 kHz frequency of the AMF, and will scale with frequency (in one embodiment up to a GHz).

The SAR of the nanowires in a cryoprotective composition may vary based on the concentration of the nanowires. If the concentration of the nanowires is too low, the SAR may be too low to warm the sample at a rate above the critical warming rate. The SAR and the concentration of the nanowires in the cryoprotective composition can be sufficiently high enough to warm the sample above the critical warming rate.

The SAR of the nanowires in the cryoprotective composition can also be increased by aligning the nanowires in a parallel orientation to the AMF. The SAR is calculated from a plot of temperature versus time during heating. Alignment of the nanowires before or during cooling can preserve the parallel orientation of the nanowires in the cryopreserved composition. The SAR of the composition with parallel nanowires can be higher that the SAR of the composition with perpendicular or random nanowires.

In one embodiment, the SAR of the Co₃₅Fe₆₅ nanowires is above 1500 W/g, or above 1550 W/g, or above 1580 W/g, or above 1590 W/g for 1 mg Co₃₅Fe₆₅/ml of Bum Co₃₅Fe₆₅ nanowires in glycerol.

The cryoprotective composition with the nanowires may be characterized by determining the hysteresis loop at various AMF. In some embodiments, the orientations, e.g. parallel to AMF, and the AMF applied to the sample can be optimized to increase the area within the hysteresis loop.

The nanowires in the cryopreserved composition may be aligned. This alignment of the nanowires may be performed before and/or after the biological sample has been added. In one embodiment, the alignment may be performed prior to cooling. In another embodiment, the alignment may be performed during the cooling of the composition. The alignment can result in the nanowires being in a parallel alignment to the AMF. Alignments that are perpendicular or random alignments to the AMF are also within the scope of this description.

A variety of fields and field strengths can be used to align the nanowires. Fields can be applied by magnetic coils (with DC or low frequency currents) or by permanent magnets. Fields used to align nanowires may be, for example, less than about 50 Oe, or less than about 30 Oe, or less than about 20 Oe, or less than about 10 Oe, or less than about 5 Oe. In one embodiment, the field to align nanowires can be about 10 Oe.

In some embodiments, the magnetic nanowires can include superparamagnetic nanowires. In other embodiments, the magnetic nanowires can include ferromagnetic nanowires. In some embodiments, the magnetic nanowires can include a combination of any two or more types of magnetic nanowires. In some embodiments, as noted briefly above, the magnetic nanowires can aggregate. In such embodiments, the magnetic nanowires can interact with one another. In some of these embodiments, one can tune the aggregation of nanowires to enhance or diminish the heating rate in a particular application, as desired.

The magnetic nanowires can be present in the cryoprotective composition in an amount sufficient to provide minimum at least 0.01 mg of magnetic atoms per milliliter of the vitrified tissue such as, for example, at least 1.0 mg/ml, at least 2.0 mg/ml, at least 3.0 mg/ml, at least 4.0 mg/ml, at least 5.0 mg/ml, at least 6.0 mg/ml, at least 7.0 mg/ml, at least 8.0 mg/ml, at least 9.0 mg/ml, at least 10 mg/ml, at least 11 mg/ml, at least 12 mg/ml, at least 13 mg/ml, at least 14 mg/ml, at least 15 mg/ml, at least 20 mg/ml, at least 25 mg/ml, or at least 50 mg/ml. In some embodiments, the magnetic nanowires can be present in the cryoprotective composition in an amount sufficient to provide a maximum of no more than 100 mg/ml, no more than 75 mg/ml, no more than 50 mg/ml, no more than 25 mg/ml, no more than 20 mg/ml, no more than 15 mg/ml, no more than 10 mg/ml, no more than 9 mg/ml, no more than 8 mg/ml, no more than 7 mg/ml, no more than 6 mg/ml, or no more than 5 mg/ml. In some embodiments, the amount of the magnetic nanowires in the cryoprotective composition may be characterized as a range having endpoints defined by any minimum amount listed above and any maximum amount listed above that is smaller than the maximum amount.

To maintain uniaxial anisotropy, the magnetic sections of the nanowires should have aspect ratios of the diameter:length of between about 1:2 and about 1:5; or between 1:5 and about 1:10; or between about 1:10 and about 1:20. Ratios of the length that is 20× greater than the diameter are also within the scope of this description. In one embodiment, the diameter:length aspect ratio can be about 1:5.

The nanowires may be fabricated to include a unique identifier code. The unique identifier code(s) can be documented when the nanowires are added to a cryoprotective composition with a biomaterial. When the biomaterial is warmed for transplantation or other uses, the barcode(s) can confirm that the thawing and/or warmed specimen is the correct specimen. The identifier can be created using the chosen magnetic material and/or multilayers of magnetic materials, sometimes with layers of non-magnetic materials. The identifier can be identified by magnetic measurements at multiple frequencies from, for example, DC to THz.

In one exemplary embodiment, Co₃₅Fe₆₅ nanowires (200 nm diameter, 0.5-16 μm long) at different concentrations (0.0625-10.0 mg Co₃₅Fe₆₅/ml) were used in a composition. The longest, highest aspect ratio nanowires had the highest SAR values for concentrations 1-2 mg Co₃₅Fe₆₅/ml. At higher concentrations of 5-10 mg Co35Fe65/ml the SAR values may be reduced due to increased dipole-dipole interactions.

In some embodiments, the present description can include cryoprotective compositions that include one or more cryoprotective agents and magnetic nanowires effective for warming a cryopreserved specimen that includes biomaterial with minimal damage to the biomaterial. The cryoprotective agent can include any material suitable for the cryopreservation of biomaterials. Exemplary suitable cryoprotective agents include, for example, combinations of alcohols, sugars, polymers and ice blocking molecules that alter the phase diagram of water and allow a glass to be formed more easily (and/or at higher temperatures) while also reducing the likelihood of ice nucleation and growth during cooling or thawing. In most cases, cryopreservative agents are not used alone, but in cocktails. In the case of vitrification solutions, exemplary cryopreservative cocktails are reviewed in Fahy et al. Cryobiology 48(1):22-35, 2004 and incorporated in its entirety by reference herein.

In some embodiments, the cryoprotective agent may be present in the composition at a molarity of no more the 9 M such as, for example, no more than 6M, no more than 5 M, no more than 4 M, no more than 3 M, no more than 2 M, no more than 1 M, no more than 900 mM, no more than 800 mM, no more than 700 mM, no more than 600 mM, no more than 500 mM, or no more than 250 mM

In some embodiments, the cryopreserved biomaterial can include biomaterial perfused with or suspended in a volume of the cryoprotective composition having a smallest linear dimension of 0.1 mm. In some embodiments, the smallest linear dimension can be, for example, at least 0.1 mm, at least 0.5 mm, at least 1 mm, at least 2 mm, at least 5 mm, at least 1 cm, at least 2 cm, at least 5 cm, at least 10 cm, at least 25 cm, at least 50 cm, or at least 100 cm. In the embodiments in which the biomaterial is perfused with the cryoprotective composition, the dimension listed above may be, in effect, the dimension of the biomaterial. In embodiments in which the biomaterial is suspended in a cryoprotective composition, the dimension may reflect a vessel containing the cryopreserved biomaterial and/or a vessel in which the cryopreserved biomaterial was cooled.

In some embodiments, the present description can include a biomaterial such as, for example, an organ or a portion thereof that is perfused with or suspended in a cryoprotective composition as described herein. The perfused and/or suspended biomaterial may be vitrified and subsequently thawed when needed.

In some embodiments, the present description can include a method of cryopreserving a biomaterial. The method can include a cryoprotective composition as described herein and cooling the biomaterial in the cryoprotective composition to a suitable cryopreservative temperature. The biomaterial may be perfused with the cryoprotective composition, suspended or immersed in the cryoprotective composition. Suitable cryopreservative temperatures can include, for example, a temperature below the glass transition temperature of the cryoprotective agent in the cryoprotective composition. As one example, the glass transition temperature of 6 M glycerol is −100° C. Accordingly, the biomaterial may be cooled to a maximum temperature of no more than 0° C. such as, for example, no more than −20° C., no more than −40° C., no more than −80° C., no more than −100° C., no more than −120° C., no more than −130° C., no more than −140° C., no more than −150° C., no more than −160° C., no more than −170° C., no more than −180° C., no more than −190° C., or no more than −200° C. In some embodiments, suitable cryopreservative temperatures can include a minimum temperature of no less than −220° C., no less than −200° C., or no less than −150° C. In some embodiments, suitable cryopreservative temperatures can be characterized as a range having as endpoints any maximum temperature listed above and any minimum temperature listed above that is less than the maximum temperature. In some embodiments, a suitable cryopreservative temperature may be the boiling point of nitrogen, −196° C. The approach is particularly useful in cryoprotective systems where the glass transition is below 0° C., when biomaterial may be subject to devitrification during thawing.

The biomaterial with the cryoprotective composition may be cooled to the cryopreservative temperature at a rate effective for cryopreservation. Cooling rates can promote vitrification of the perfused biomaterial. In some embodiments, the perfused biomaterial may be cooled at a minimum rate of at least 1° C. per minute (° C./min) such as, for example, at least 2° C./min, at least 5° C./min, at least 10° C./min, at least 15° C./min, at least 20° C./min, at least 25° C./min, at least 30° C./min, at least 40° C./min, at least 50° C./min, at least 60° C./min, at least 70° C./min, at least 100° C./min, at least 1000° C./min, or multiple thousands ° C./min. In some embodiments, the perfused biomaterial may be cooled at a maximum rate of no more than 100° C./min such as, for example, no more than 80° C./min, no more than 60° C./min, no more than 50° C./min, no more than 40° C./min, no more than 30° C./min, or no more than 20° C./min. In some embodiments, the cooling rate may be within a range of cooling rate having endpoints defined by any minimum cooling rate listed above and any maximum cooling rate listed above that is greater than the minimum cooling rate. In embodiments involving larger systems, the cooling process can involve use of a high pressure freezing vial as described by Fahy et al. Cryobiology 48(2):157-178, 2004. Added pressure—e.g., up to 1000 atm—can reduce the ability of ice to nucleate and grow within the sample during cooling. However, samples cooled in this manner can require rapid thawing to avoid devitrification and cracking.

In some embodiments, the method may include aligning the nanowires in the cryoprotective composition. The aligning can include applying an external field such as a DC field using either magnetic coils and/or permanent magnets as described herein.

In some embodiments, the present description can also include a method for warming of cryopreserved tissues preserved in a cryoprotective composition that includes magnetic nanowires. The use of magnetic nanowires for warming a cryopreserved biospecimen can provide faster, more uniform heating rates that can, in turn, reduce devitrification and/or other detrimental effects on cryopreserved biospecimens. Further, the use of magnetic nanowires to warm a cryopreserved biospecimen may facilitate cryopreservation of larger systems with lower molarity cryoprotectants, thereby reducing toxicity issues.

Also as used herein, “minimal damage” refers to an amount of damage to the thawed biomaterial insubstantial enough so that the biomaterial retains its desired biofunctionality when thawed. Thus, minimal devitrification can allow for some degree of damage and the permissible amount may vary depending upon the intended use of the biomaterial after thawing. In this context, “damage” is a collective term that generically refers to damage to biomaterial that can commonly result in failed cryopreservation. Such damage includes, for example, devitrification and/or cracking In embodiments in which the biomaterial includes, for example, an organ for transplantation, the thawed organ having “minimal damage” may sustain some damage, but remains useful for transplantation into a recipient. As another example, in embodiments in which the biomaterial includes, for example, reproductive materials (e.g., ova, sperm, semen), the specimen having “minimal damage” may include an acceptable percentage of non-viable cells while retaining a useful percentage of viable cells.

The magnitude of the magnetic field applied to the cryopreserved composition for warming can vary. A smaller applied field is more energy efficient and can be alternated at higher frequencies in a cost effective manner.

Magnetic nanowires can be designed such that magnetization reversal mechanisms will occur at low fields, e.g. 20 kA/m which are easily achieved up to high frequencies (kHz to MHz). For example, vortex domain walls can be nucleated and propagated at low fields. High saturation magnetizations enable vortex walls to dominate reversal mechanisms, even with small diameter nanowires, yet the height of the hysteresis loop remains large (2.45 T) for maximum heating in a low field at high frequencies.

In some embodiments, the method of warming a cryopreserved biomaterial can include obtaining a biomaterial cryopreserved with a cryopreservative composition as described herein, and subjecting the cryopreserved biomaterial to an AMF, and for a duration, effective to warm the biomaterial. In some embodiments, the biomaterial may exhibit minimal devitrification, as defined herein, while being warmed.

In some embodiments, the electromagnetic energy can include an alternating magnetic field, or rotating magnetic field or electromagnetic radiation. The frequency of the electromagnetic energy can be between about 1 kHz and about 1 GHz. In some embodiments, the electromagnetic energy can exhibit a frequency of at least about 10 0kHz, or at least about 1 MHz, or at least about 10 MHz or at least about 100 MHz, or at least about 500 MHz. In some embodiments, the electromagnetic energy can exhibit a frequency of no more than 1 GHz.

In some embodiments, the AMF may have a minimum strength of at least 10 kA/m such as, for example, at least 20 kA/m, at least 30 kA/m, at least 50 kA/m, at least 75 kA/m, or at least 100 kA/m. In some embodiments, the radio frequency filed may have a maximum strength of no more than 200 kA/m such as, for example, no more than 150 kA/m, no more than 100 kA/m, no more than 80 kA/m, no more than 50 kA/m, or no more than 25 kA/m. In some embodiments, the strength of the AMF may be characterized as a range having as endpoints any minimum strength listed above and any maximum strength listed above that is greater than the minimum strength and may be time-dependent. In some embodiments, the AMF may have a strength of from about 10 kA/m to about 100 kA/m. In one embodiment, the AMF can have a strength of 25 kA/m.

The methods described herein can lead to rapid and uniform heating. This can lead to improved viability of the cryopreserved and thawed biomaterial.

The present description can also include an apparatus for warming a cryopreserved biomaterial. The apparatus can include a power supply and a magnetic coil. In one embodiment, the warming apparatus can be as shown in FIG. 8. The power supply can be a DC power supply connected to a power source. A variety of power sources can be used and all are within the scope of this description. The magnetic coil can be a Helmholtz coil operably connected to the power supply. A cryopreserved sample/biomaterial can be placed within the magnetic coil. The cryopreserved sample can include biomaterial, CPA and magnetic nanowires as described herein. The apparatus may include a sample holder to hold the cryopreserved sample. The DC power supply can be activated or turned on to generate the magnetic field to align the magnetic nanowires. The power supply and/or the magnetic coil can be connected to other components such as a computer and/or other I/O systems to monitor the warming, temperature and other parameters.

Also in the preceding description, particular embodiments may be described in isolation for clarity. Unless otherwise expressly specified that the features of a particular embodiment are incompatible with the features of another embodiment, certain embodiments can include a combination of compatible features described herein in connection with one or more embodiments.

For any method disclosed herein that includes discrete steps, the steps may be conducted in any feasible order. And, as appropriate, any combination of two or more steps may be conducted simultaneously.

Compositions and methods are illustrated by the preceding description. It is to be understood that the particular examples, materials, amounts, and procedures are to be interpreted broadly in accordance with the scope and spirit of the description as set forth herein.

### EXAMPLES

### Materials and Methods

A. Nanowire Fabrication and Coating

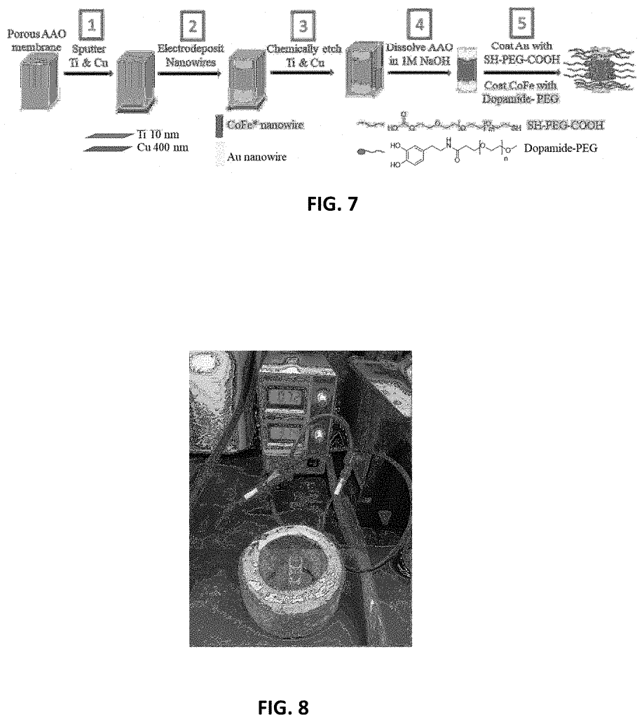

Various length Co₃₅Fe₆₅ nanowires (1-16 μm) were fabricated and analyzed as shown in FIG. 7, FIG. 2A and FIG. 2B. 8 μm Co, Fe and Ni nanowires were electrodeposited into 50 μm thick commercial AAO templates (Whatmann Inc. or InRedox). The nominal nanopore diameter was 200 nm. A metallic seed layer of Ti (10 nm) was sputter deposited onto one side of the AAO templates, followed by 400nm of Cu (either electrodeposited or sputtered) to act as a back-electrode. See FIG. 7 for a diagram depicting NW fabrication steps.

An initial layer of Cu was electrodeposited inside the nanopores and 500 nm Au tips were electrodeposited on both ends of the Co₃₅Fe₆₅, Fe, Co, or Ni nanowires. Table 1 shows a detailed description of the electrolytes and electrodeposition parameters used. The Co₃₅Fe₆₅ electrodeposited under these conditions has been found to have a high Ms (248 emu/g) while maintaining coercivity. The electrolytic concentration, pH, and reduction potentials for Au, Ni, Co, Fe, and CoFe nanowires (NWs) are shown in Table 1. All reduction potentials are against a saturated Ag/AgCl reference electrode.

The electrolyte solution was adjusted to pH 3.0 by adding H₂SO₄ or NaOH as needed. Pulsed potential deposition with time-on 2.5 s at -1.1V/SCE and time-off 1 s -0.7 V/SCE.

TABLE 1

| Comment | Chemical | Concentration | pH | Reduction |
|---|---|---|---|---|
| Pure Au NWs | KAu(CN)₂ | 10 g/L | 6.0 | −0.6 V |
| Supporting electrolyte | K₂PO₄ | 120 g/L | 6.0 | |
| Supporting electrolyte | KH₂PO₄ | 30 g/L | 6.0 | |
| Magnetic NWs | | | | |
| Supporting electrolyte | H₃BO₃ | 0.4 M | 3.0 | |
| Supporting electrolyte | NH₄Cl | 0.3 M | 3.0 | |
| Supporting electrolyte | Malonic acid | 0.001 M | 3.0 | |
| Wetting agent | SDS | 0.0001 M | 3.0 | |
| Ni NWs | NiSO₄ | 0.2 M | 3.0 | −0.9 V |
| Co NWs | CoSO₄ | 0.2 M | 3.0 | −0.9 V |
| Fe NWs | FeSO₄ | 0.2 M | 3.0 | −1.1 V |
| CoFe NWs | CoSO₄, FeSO₄ | 0.1 M, 0.2 M | 3.0 | −1.1 V |

After electrodepositing the nanowires, the Cu was wet etched using 1.0 M FeNO3. Then, the AAO template was dissolved in 0.7 M HPO4 and 0.2 M CrO3 at 80° C. for 60 minutes. The nanowires were magnetically separated and washed 3× with DI water. They were resuspended in 1 ml of 1 mM 2000 MW dopamide-PEG (synthesized using Sigma Aldrich chemicals), and 1 ml of 1 mM SH-PEG-COOH (Sigma Aldrich) for 12 hours to coat the magnetic and Au surfaces, respectively.

B. Nanowire Characterization

The nanowires were imaged while aligned in the AAO template using a Zeiss NEON 40 EsB CrossBeam SEM. The Co₃₅Fe₆₅ nanowires had an atomic ratio of Co:Fe=7:15±10%, as determined by EDS. The Ms of Co₃₅Fe₆₅ confirmed the composition as the high-moment alloy. A Princeton vibrating sample magnetometer (VSM) was used to measure the hysteresis loops of the Co₃₅Fe₆₅, Fe, Co, and Ni nanowires, (±5 kOe, 25 Oe/s, 25° C.), while they were still inside the AAO, aligned parallel and perpendicular to the applied field. These loops show the extremes of orientation, where random orientations will be between these extremes.

C. SAR Measurements and Calculations

To measure and calculate the SAR values, the nanowire samples with glycerol or VS55 were placed in a 1.7 ml Eppendorf tube and heated using a 1-kW Hotshot inductive heating systems with 2.75-turn, water-cooled copper coil, inner diameter 1.75 cm (Ameritherm Inc). The vial was insulated in styrofoam with sample volumes ranging from 0.1-0.5 ml, depending on the nanowire concentration. The temperature was measured and recorded in one second increments using a Teflon coated fiber-optic temperature probe and Neoptix OptiLink software (Qualitrol Corporation). The time point for 0 seconds on the temperature curve was chosen within the first few seconds after turning on the AMF. For the SAR measurements, H=20 kA/m (251 Oe) and f=190 kHz. For the nanowarming measurements, H=20, 25 or 30 kA/m and f=190 or 360 kHz, as noted in the text.

D. Cell Viability Experiments

For each trial, ˜50,000 human dermal fibroblast (HDF) cells (suspended in cell growth mediawere put into one well of a 96 well plate and left overnight to become adherent to the bottom. After 18 hours, the cell growth media was removed, and the cells were loaded concentrations of VS55 (12.5%, 25%, 50%, 75%) for 3 minutes each. Then, the 75% VS55 was removed and 100 μl of VS55 with 8 μm Co₃₅Fe₆₅ nanowires (1 or 2.5 mg Co₃₅Fe₆₅/ml) was added to each well for 3 minutes because cells are typically exposed to liquid VS55 for only 3 minutes during nanowarming. Next, the nanowire suspension was removed, and the cells were rinsed with decreasing concentrations of VS55 until they were fully loaded with Euro Collins solution, as before. Finally, the cells were stained with using a Hoechst-PI double stain and imaged using a fluorescent microscope to count the living and dead cells, N>200 cells/sample.

Results

The impact of Ms on heating was studied. 8 μm long Co₃₅Fe₆₅, Fe, Co and Ni nanowires were mixed in glycerol at various concentrations and placed in the AMF (H=20 kA/m, or 251 Oe, f=190 kHz). The SAR values were calculated using the Box-Lucas curve-fitting method, where equation (5) is used to calculate parameters A and k, which are then used to calculate SAR with equation (6):

ΔT=A(1−e^{-λ}^{^{t}}) (5)

SAR=AλC/mMNP (6)

The Box-Lucas method was used because it is reliable to calculate the SAR for be non-adiabatic systems such as this. The curve fitting was done for the first 180 seconds of the heating measurements.

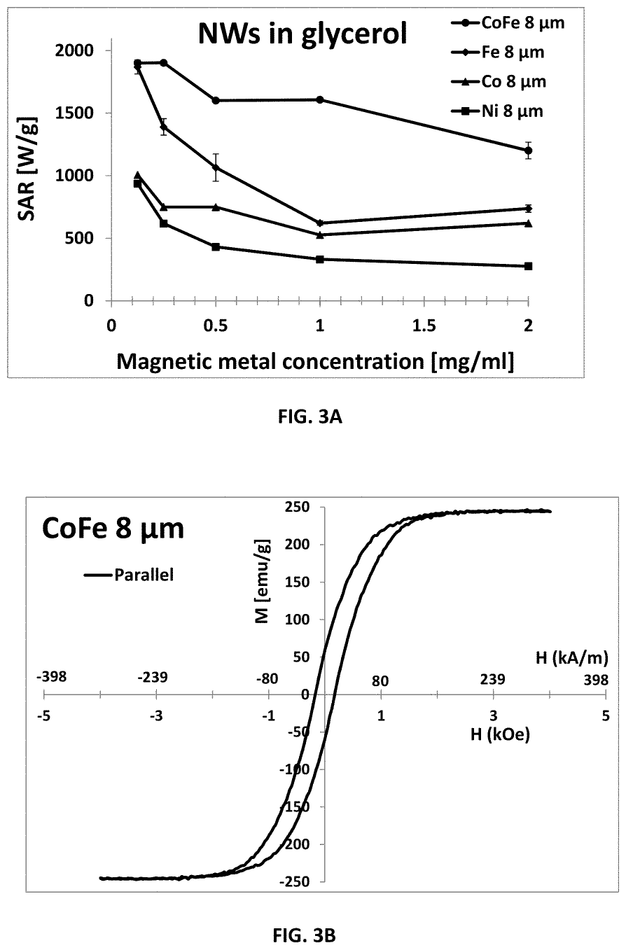

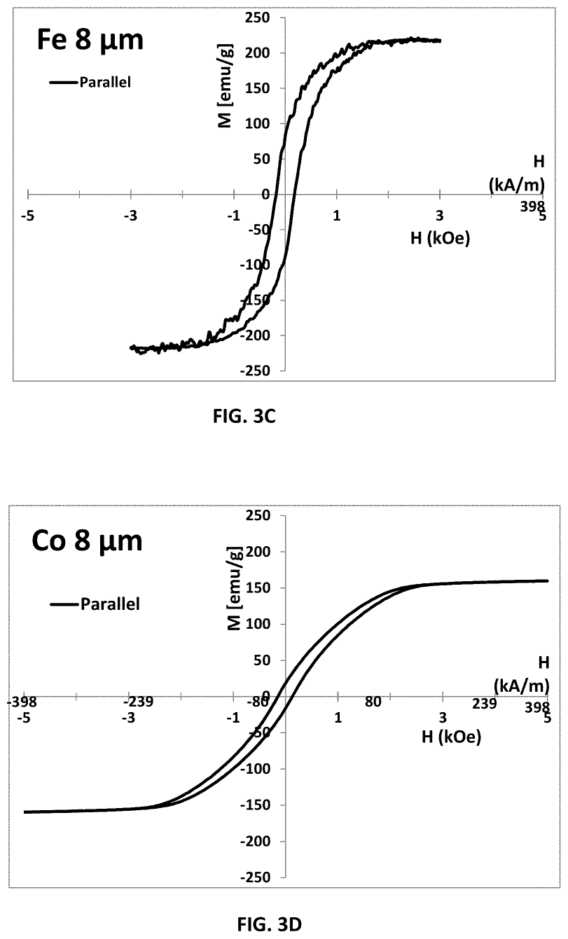

FIG. 3A shows that the highest Ms metal (Co₃₅Fe₆₅) had the highest SAR values, and SAR decreased as materials with lower Ms were used (Fe, Co, and Ni, respectively). FIGS. 3B-3D show the parallel and perpendicular hysteresis loops for the Co35Fe65, Fe, Co nanowires, while Ni is shown in FIG. 1. The Ms values are similar to the bulk values for each metal (Co₃₅Fe₆₅ 248 emu/g, Fe 218 emu/g, Co 161 emu/g, Ni 54.4 emu/g). Although SAR monotonically increased with the Ms of the nanowire materials, but the relationship was not linear for several reasons. First, Fe nanowires had lower relative SAR because Fe readily oxidizes, which can lead to canted magnetic moments and iron oxides on the surfaces, both of which lower Ms compared to the as-synthesized Ms. For reference, iron oxide exists in many forms with Ms of 0 (hematite) to 87 (magnetite) emu/g. Co nanowires also had lower relative

SAR values, most likely because Co has 10× higher crystallographic anisotropy than the other metals which may be competing with the nanowire shape anisotropy, leading to a sheared hysteresis loop 22 (FIG. 3D). This shearing reduces the area of the loop, and therefore reduces heating.

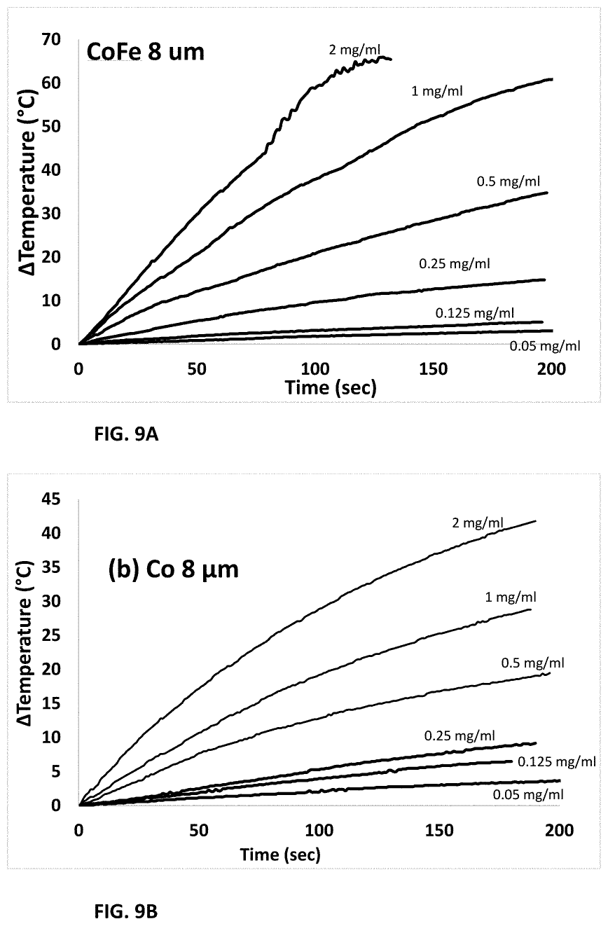

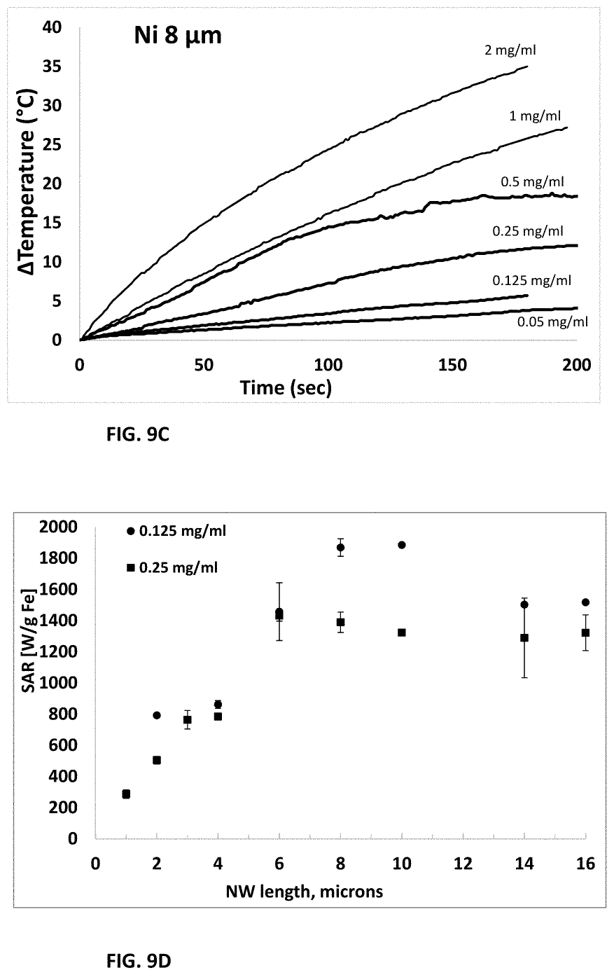

Dipole interactions between neighboring nanowires also affect the switching of the magnetic domains. The dipole interactions become more noticeable at higher nanowire concentrations and could explain why the SAR values are typically higher at lower concentrations and in every curve in FIG. 3A. See a comparison of 0.125 and 0.25 mg Co₃₅Fe₆₅/ml in FIG. 9D. For the same size nanowire, 10× increase in concentration will lead to a cubed root of 10 (or 2.15×) closer spacing (r). Since dipole fields are proportional to r-3, this can be a significant effect that increases further as spacing becomes similar in size as the nanowire dimensions.

The nanowires have a lower anisotropy field (H_{K} in FIG. 1) when they are aligned parallel with the field, which means a lower magnetic field is needed to completely flip the magnetizations. Therefore, the nanowires should generate more heat in lower magnetic fields with the nanowires aligned parallel with the AMF rather than perpendicular or randomly oriented. This is especially useful for applications heating biological tissues, for which it is preferable to use lower AMFs to avoid strong eddy currents.

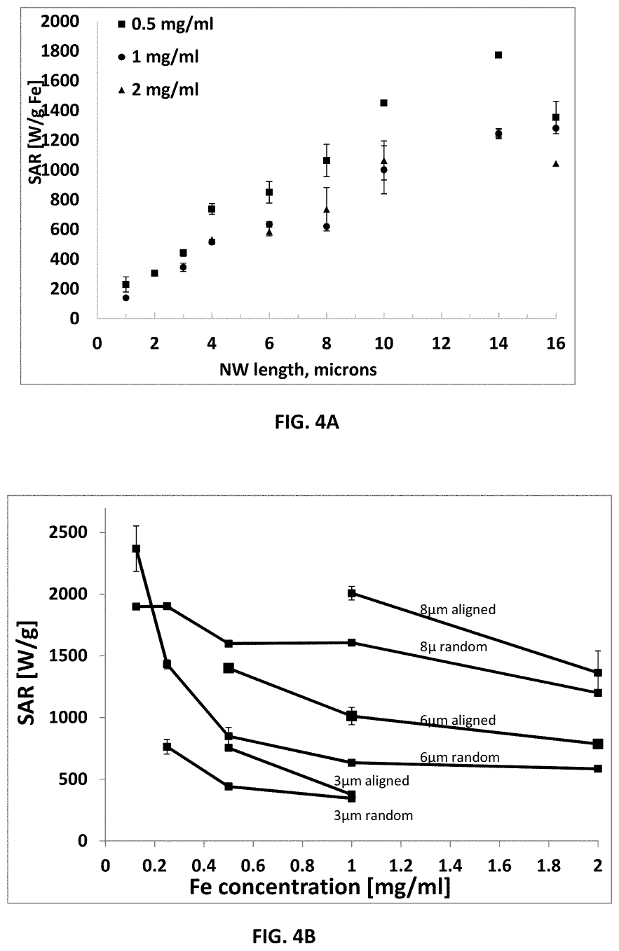

Co₃₅Fe₆₅ nanowires were used to compare how the nanowire length affects SAR values at different concentrations as shown in FIG. 4A. The SAR values increased with increasing nanowire length. The 14 and 16 μm long nanowires had SAR of 1400 W/g Co35Fe65 at 1 mg Co35Fe65/ml glycerol (H=20 kA/m and f=190 kHz). As the nanowire length increases the magnetic anisotropy also increases because the demagnetization factor is larger for longer magnetic domains. However, longer nanowires can have multiple magnetic domains so the magnetic domain length does not continue increasing with the nanowire length.

The SAR values were higher for lower concentrations for all the different length Co35Fe65 nanowires as shown in FIGS. 9A-9C. This is likely because the nanowires have fewer dipole interactions at lower concentrations, because they are farther apart from each other. For 16 μm nanowires, which have larger magnetic dipole fields, they are 32 μm apart at 0.125 mg/ml but only 7.6 μm apart at 10 mg/ml.

Although the SAR values are higher at low concentrations, the temperature increase per minute is smaller because the nanowire mass is much smaller. It would be difficult to achieve the rapid heating rates (above the CWR) needed to re-warm vitrified samples.

Glycerol was used for these heating experiments because it has a higher viscosity and density than water, with a lower Cp. The high viscosity glycerol prevented the nanowires from settling to ensure a uniform concentration during heating. It also restricted the rotation movement of the nanowires during the measurement. This motion restricting environment is similar to having nanowires dispersed in vitrified VS55 or another CPA. With the nanowires suspended in glycerol, they could be aligned by placing the sample in a uniform magnetic field (H=1.6 kA/m) generated by a Helmholtz coil (750 turns) and a 3-amp DC power supply as shown in FIG. 8.

Heating curves were measured for several samples with the nanowires aligned parallel to the AMF prior to measurement as shown in FIG. 4B. A dramatic increase in SAR was measured for the aligned samples. For the 8 μm Co₃₅Fe₆₅ nanowires the SAR increased from 1296 W/g Co₃₅Fe₆₅ (randomly oriented) to 1594 W/g Co₃₅Fe₆₅ for aligned nanowires. These experimental results agree with the magnetic hysteresis data in FIG. 3B. When the nanowires are aligned parallel to each other and the AMF (instead of randomly oriented) they have a lower anisotropy field, so the system will reach magnetic saturation at lower applied fields. In addition, the parallel NWs have a higher Mr, so they will have more area inside the hysteresis loop and better heating at lower fields.

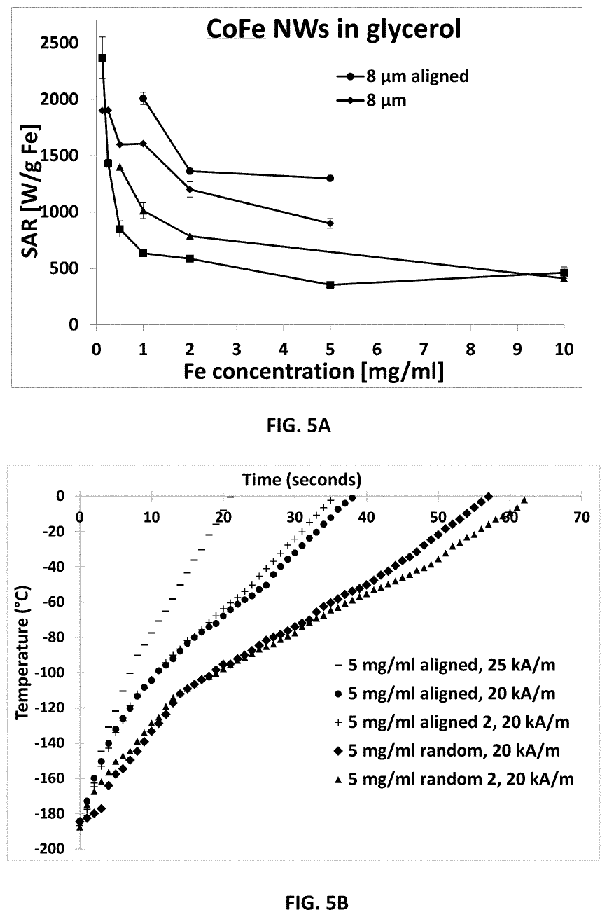

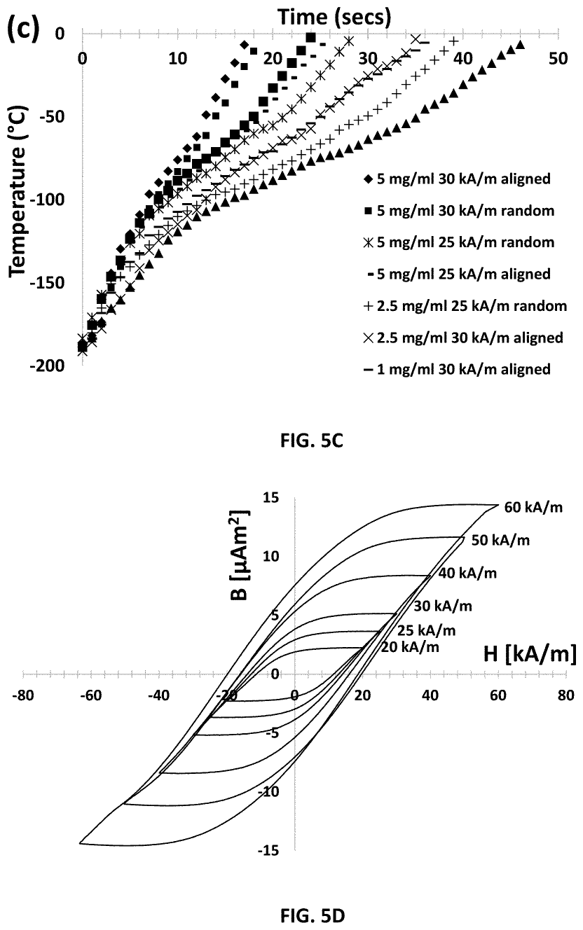

Because cryogenic nanowarming typically requires high concentrations (>2 mg Fe/ml) to achieve high heating rates, two nanowire samples were measured in glycerol. FIG. 5a shows that nanowire alignment increased SAR values at 2 mg/ml and 5 mg/ml. At 10 mg/ml the SAR values were similar for aligned or random nanowires. Presumably, the nanowires apply dipole fields to each other at such a high concentration, making it more difficult to complete magnetic saturation in the sample. Using higher AMFs should help reach saturation, as discussed below.

Co₃₅Fe₆₅ nanowires were dispersed in a standard cryopreservation agent, VS55, at concentrations of 1, 2.5, 5, and 10 mg Co35Fe65/ ml. FIG. 5B shows the heating curves for 8 μm Co35Fe65 nanowires (5 mg/ml) heated in VS55 at 20 kA/m and 360 kHz, with or without magnetic alignment. The nanowires heated at least an order of magnitude above the CWR for

VS55 (50° C./min) and much faster than commercial Ferrotec iron oxide particles coated with mesoporous silica. This is expected, since these Co₃₅Fe₆₅ nanowires have more area inside their hysteresis loops, and therefore higher SAR values than the iron oxide particles. When the AMF was increased to 25 kA/m, with the nanowires aligned, the heating rate increased even more.

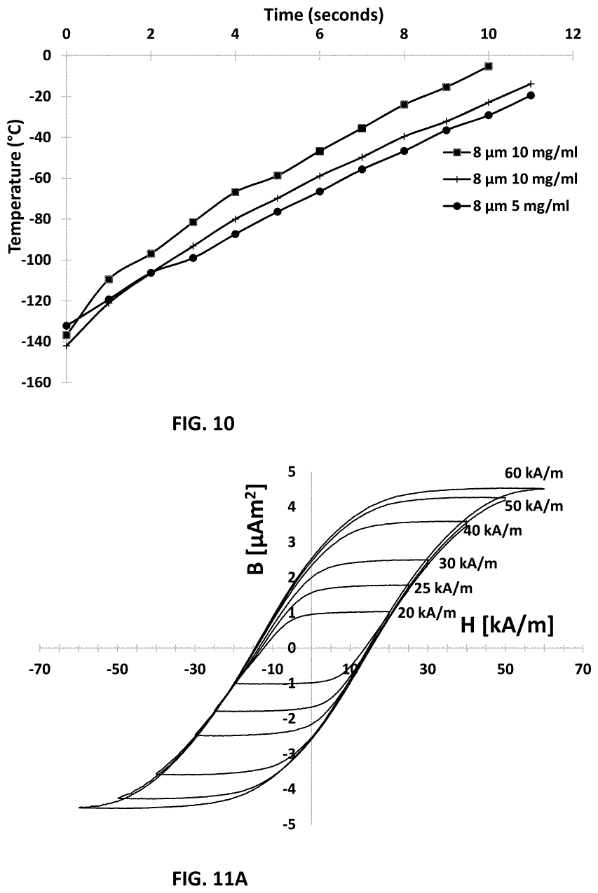

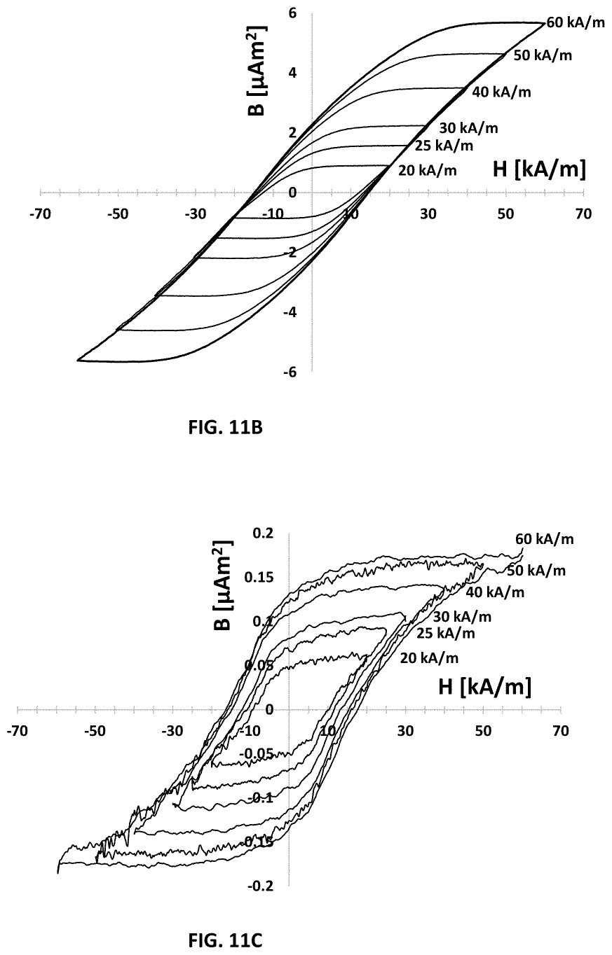

Several different combinations of concentration (1, 2.5, 5, or 10 mg Fe/ml), AMF (25 or 30 kA/m), and nanowire alignment were tested, with the results in FIG. 5C. All of these combinations resulted in fast heating rates, and the fastest heating rate of 1000° C./min (between −123° C. and −80° C.) was achieved using aligned 8 μm Co35Fe65 nanowires, 10 mg Co35Fe65/ml as shown in FIG. 10. The dramatic increase in heating rates with the AMF at 25 or 30 kA/m, can be easily explained using the minor hysteresis loops as shown in FIG. 5D. The magnetization of the Co₃₅Fe₆₅ nanowires (8 μm) aligned in an AAO membrane parallel to the applied field increased by increasing the AMF from ±20 to ±60 kA/m (±0.25, to ±0.75 kOe). Therefore, the area inside of the minor loops minor increased as the sample magnetization approached saturation (from FIG. 3B, Hk=200 kA/m, or 2.5 kOe). A similar family of loops for Fe, Co, and Ni nanowires are shown in FIGS. 11A-11C. The 1 kW heating coil cannot achieve AMFs above 30 kA/m; however, larger 15 kW systems can achieve fields as high as 60 kA/m which would be useful to nanowarm larger volumes. With higher AMFs, there may be a safety concern due to eddy currents. However, the AMF can be turned off once the sample reaches −20° C. to avoid damaging the tissues or cells, or a lower frequency can be used.

Importantly, the Co₃₅Fe₆₅ nanowires achieved heating at 256° C./min using only 1 mg Co35Fe65/ml. This means the nanowires could potentially be used for nanowarming using only a fraction of the MNP mass required when using typical iron oxide particles (10 mg Fe/ml). These results demonstrate that the nanowire heating rates can be tuned depending on the concentration and the AMF strength, which offers useful flexibility to achieve rapid heating rates in larger volumes for tissues or organs.

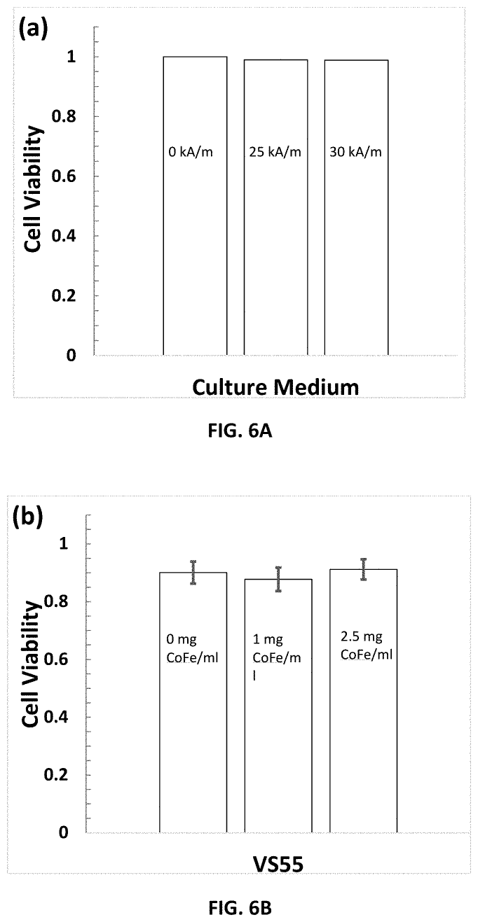

After successfully demonstrating the heating rates in vitrified VS55, the cytotoxicity of the PEG coated Co35Fe65 nanowires, in VS55 at 4° C., was measured using HDF cells. HDF cells in cell culture medium exposed to a 25 or 30 kA/m AMF for 3 minutes had similar viability as cells with no AMF exposure (FIG. 6A). These results indicate that Co35Fe65 nanowires with a 25 or 30 kA/m AMF will not be harmful in nanowarming cells or tissues. HDF cells had similar viability in VS55 with 0, 1, or 2.5 mg Co35Fe65/ml of 8 μm Co35Fe65 nanowires (FIG. 6B).

Note that VS55 can be toxic to the cells, especially above −20° C., so exposure was limited to 3 minutes, as it would be during nanowarming procedures.

High moment Au-tipped nanowires were studied for potential as nanowarming agents. First, Co35Fe65, Fe, Co, and Ni nanowires were dispersed in glycerol to inhibit nanowire motion during heating studies in an alternating magnetic field (AMF). They were found to have SAR values that decreased monotonically with their saturation magnetizations (248, 220, 170, and 55 emu/g, respectively). This was explained by a reduction in the area of the hysteresis loop since the height of the loop is 2× Ms and the width is 2× the coercivity, Hc. Hysteresis loops were measured for the extremes of orientation (parallel and perpendicular to the applied field), and it is clearly seen that switching fields are lower for parallel orientations. Subsequently Co35Fe65 nanowires were oriented parallel to the AMF (190 kHz, 20 kA/m), which led to an increase from 1276 (random) to 1594 (aligned) W/g Co35Fe65 ±20 at 1 mg metal/ml glycerol for 8μm-long Co35Fe65 nanowires. Minor loops were also measured to show the increase in area obtained increasing the AMF from 20 to 60 A/m2. All of these studies were done from room temperature, so the next study involved freezing Au-tipped Co35Fe65 nanowires in VS55, both randomly oriented and aligned parallel to the AMF. Very fast heating (1000° C./min between −123° C. and −80° C.) was obtained for aligned nanowires, which is 20× higher than the critical warming rates (−50° C./min) of most cryopreservation agents. With these promising thermal results indicating that nanowires have excellent potential as nanowarming agents, cell toxicity in the presence of the nanowires was confirmed to be minimal and the door is open for future tissue warming studies.

Although the present invention has been described with reference to preferred embodiments, workers skilled in the art will recognize that changes may be made in form and detail without departing from the spirit and scope of the invention.

What is claimed is:

1. A cryopreserved composition comprising a cryoprotective composition and a biomaterial, wherein the cryoprotective composition comprises at least one cryoprotective agent and magnetic nanowires, the biomaterial perfused with and/or suspended in the cryoprotective agent in the cryopreserved composition.

2. The composition of claim 1, wherein the biomaterial in the cryopreserved composition has a minimum dimension of 0.1 mm.

3. The composition of claim 1, wherein the at least one cryoprotective agent has a molarity of less than about 9 M in the cryoprotective composition.

4. The composition of claim 1, wherein the magnetic nanowires are CoFe nanowires

5. The composition of claim 1, wherein the magnetic nanowires are Co₃₅Fe₆₅nanowires.

6. The composition of claim 1, wherein the total concentration of magnetic nanowires in the cryoprotective composition is between about 1 mg CoFe/mL and about 100 mg CoFe/mL.

7. The composition of claim 1, wherein the nanowires have a length between about 100 nm and about 20 μm.

8. The composition of claim 1, wherein the nanowires have a diameter between about 10 nm and about 200 nm.

9. The composition of claim 1, wherein the nanowires are tipped with gold.

10. The composition of claim 1, wherein the biomaterial comprises an organ or portion thereof, a tissue or portion thereof, and/or cells.

11. The composition of claim 1, wherein the nanowires in the cryopreserved composition are aligned in a parallel manner.

12. A method of cryopreserving a biomaterial comprising:
placing a biomaterial in contact with a cryoprotective composition, wherein the cryoprotective composition comprises a cryoprotective agent and magnetic nanowires; and
cooling the biomaterial in the cryoprotective composition to form a cryopreserved composition.

13. The method of claim 12, wherein the method further comprises aligning the magnetic nanowires prior to or during cooling of the biomaterial in the cryoprotective composition.

14. The method of claim 12, wherein the method further comprises applying electromagnetic energy to the cryopreserved composition to excite the magnetic nanowires and warm the biomaterial.

15. A method of treating a cryopreserved biomaterial, the method comprising:
applying electromagnetic energy to a biomaterial cryopreserved in a cryoprotective composition, wherein the cryoprotective composition comprises at least one cryoprotective agent and magnetic nanowires, wherein the electromagnetic energy is applied to the biomaterial to excite the magnetic nanowires and warm the biomaterial.

16. The method of claim 15, wherein the electromagnetic energy comprises an alternating magnetic field (AMF).

17. The method of claim 16, wherein the AMF applied is between about 20-100 k/m.

18. The method of claim 15, wherein the cryopreserved biomaterial has a volume with a minimum dimension of at least 0.1 mm.

19. The method of claim 15, wherein the cryopreserved biomaterial is warmed at a rate of at least 50° C./minute throughout.

20. The method of claim 15, wherein the nanowires are aligned in the cryopreserved biomaterial.
